(19) United States
(12) Patent Application Publication
(10) Pub. No.: US 2008/0220984 A1
(43) Pub. Date: Sep. 11, 2008

(54) Method for diagnosis of physiological states by detecting patterns of volatile analytes

(76) Inventors: Frank V. Bright, Williamsville, NY (US); Alexander N. Cartwright, Williamsville, NY (US); Venugopal Govindaraju, Williamsville, NY (US); Wesley Hicks, Angola, NY (US); Albert H. Titus, Buffalo, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/069,662

(22) Filed: Feb. 11, 2008

Related U.S. Application Data
(63) Continuation-in-part of application No. 11/076,729, filed on Mar. 10, 2005.
(60) Provisional application No. 60/900,676, filed on Feb. 9, 2007.
(60) Provisional application No. 60/551,818, filed on Mar. 10, 2004.

(51) Int. Cl. C40B 30/10

(52) U.S. Cl. 506/12

(57) ABSTRACT

Provided is a non-invasive method for identification of non-physiological, physiological or diseased states based on the volatiles in gas or biogas samples from individuals. The method uses a sensor array comprising a plurality of distinct sensors which differ from other sensors by the sensing molecules or the sol-gel holding material composition. In response to a combination of volatiles, a pattern of responses is generated which can be correlated to particular non-physiological, physiological or diseased state.

This application claims priority to U.S. provisional application No. 60/900,676 filed on Feb. 9, 2007, and is also a continuation in part of U.S. non-provisional application Ser. No. 11/076,729 filed on Mar. 10, 2005, which in turn claims priority to U.S. provisional application No. 60/551,818 filed on Mar. 10, 2004, the disclosures of which are incorporated herein by reference.

This work was supported by funding from the Government under grant numbers CHE-0315129 and BES-0330240 from the National Science Foundation. The Government has certain rights in the invention.

### BACKGROUND OF THE INVENTION

Most methods for detection and quantification of chemical substances are performed in well-outfitted laboratories, requiring skilled personnel, large amounts of costly reagents, and long analysis times. To address cost and time concerns, detection methods which allow the simultaneous quantification of multiple analytes in a sample, are less expensive, and simpler to construct and operate are being developed. However, there are many altered physiological states (including diseased states), for which no particular marker has been identified that can be reliably used as a diagnostic indicator. In such situations, the ability to detect particular analytes does not help in quick and accurate diagnosis. Thus, there is a need to develop methods whereby physiological or diseased states can be diagnosed in the absence of individual diagnostic indicators.

For traditional medical diagnosis, aspirates, blood, and urine are the most common biofluid samples for obtaining metabolites/biomarkers for evaluation. A medium that has received far less attention within the medical community is biogas samples (such as expired gases or odors from one's breath or from other body parts). These samples can be large in volume, are much safer to handle in comparison to biofluids and offer the potential of completely non-invasive evaluation and investigation, thus providing a significant advantage over aspirate, urine and blood sampling. However, efficient methods to use biogas samples for diagnosis of physiological or diseased states have heretofore been unavailable.

### SUMMARY OF THE INVENTION

The present invention provides a method for identification of an ensemble of volatiles without having to know the identity of the individual components of the ensemble. Thus, this method can be used for diagnosis of a physiological or diseased states. The method comprises the steps of providing a sensor array comprising a plurality of distinct sensors having different holding materials or sensing molecules or both. The sensor array is exposed to the test biogas sample. The response of the sensors is recorded and a pattern is generated. The pattern can be compared to a control sample to provide indication of the presence or absence of the gas ensemble profile in the test sample. The comparison with the control sample can be done by visual inspection or the pattern could be read by a computer. Additionally, neural networks can be trained to identify the presence or absence of physiological or diseased states.

In various embodiments, the holding materials are formed by xerogel materials and the sensing molecules are luminophores.

### BRIEF DESCRIPTION OF THE DRAWINGS

FIG. 1. Graphical representation of the components used in the present method for diagnosis of altered physiological states by detecting patterns of volatile analytes.

FIG. 2a is a false color fluorescence image of an array of xerogel-based sensor elements developed for oxygen detection.

FIG. 2b shows the unique sensitivity of each xerogel array element obtained by controlling the xerogel composition.

FIG. 3. False color difference images (array challenged with a N₂ atmosphere minus the array challenged with a gaseous sample) from a 5×5 xerogel-based sensor array wherein each sensor element is derived from a unique xerogel formulation (25 discrete formulations). Specimens are the head space gases from male urine donors recorded 12 seconds after array exposure.

FIG. 4. Histogram of sensor element response to breath samples from cancer patients and a control group with no diagnosed cancer. Image of sensor array used to collect data in Example 2.

FIG. 5. Graphical representation of elimination of environmental noise using Adaline-Adaptive Filtering technique.

FIG. 6. Graphical representation of the steps for training a neural network by generating a rule set for identification of physiological or diseased states.

### DETAILED DESCRIPTION OF THE INVENTION

The present method provides non-invasive method for identification of physiological or diseased states based on the volatile analytes in biogas samples from an individual. The method uses a sensor array comprising a plurality of distinct sensors, wherein each sensor (or set of sensors) differs from other sensors (or set of sensors) by the sensing molecules or the holding material composition such that a group of sensors can generate a pattern of responses that can be correlated to particular physiological to diseased states. Thus, the method comprises the steps of providing a sensor array of distinct sensors comprising different sensing molecules and/or holding material compositions; exposing the sensor array to a biogas specimen from an individual, which results in the generation of a specific combination of responses of the different sensors; generating a pattern based on the characteristics of the responses of the sensors and comparing the pattern obtained from the test specimen of to a control specimen; or subjecting the responses to a rule set from a trained neural network.

In the present method, any gaseous test sample can be evaluated. In one embodiment, the gaseous test sample can be a biogas sample. A biogas sample (also referred to herein as biogas specimen) as described herein means a gaseous sample directly emanating from the individual (such as the individual's breath) or it can be the headspace gas from a liquid or tissue sample from the individual such as blood urine or other body fluids or tissues or organs. The biogas sample may contain vapor materials such as water vapors and aqueous aerosols.

For the method of the present invention, arrays of discrete sensor elements can be formed on the face of a light source and detected with an array-based detector. For example, formation of sensor arrays on the face of a light emitting diode (LED) and the simultaneous detection of multiple analytes are described in U.S. Pat. Nos. 6,492,182, 6,582,966 and 6,589,438, incorporated herein by reference. In operation, the LED serves as the light source to simultaneously excite the chromophores/luminophores within all the sensors on the LED face and the target analyte-dependent absorbance/emission from all the sensors can be detected by an array detector (e.g., charge coupled device (CCD), complementary metal oxide semiconductor (CMOS)). Depending upon the gas profile of the biogas sample, a distinct pattern will be generated based on the responses of the sensors. The response of each sensor is characterized as whether a sensor is responding or not, and/or other characteristics of the response (such as the intensity of the response). The pattern can then be compared to a control pattern.

The control pattern may be a positive control pattern or a negative control pattern. A negative control pattern can be generated by a gas specimen which has an ensemble of gaseous components known to be associated with the absence of a particular condition. A positive control pattern, on the other hand, can be generated by gas specimen which has an ensemble of gaseous components known to be associated with the presence of a particular condition.

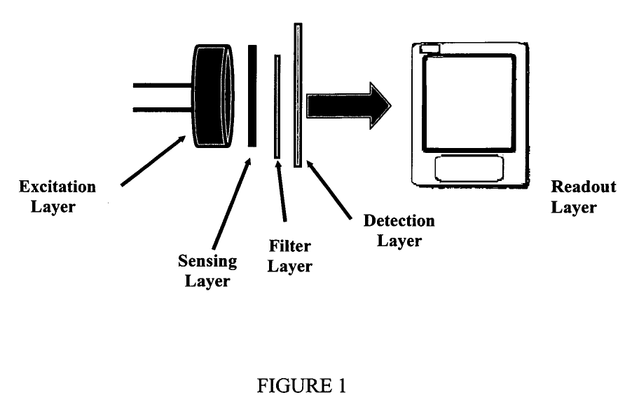

The sensor array may be provided in the form of a device. The device may be a simple hand-held device. The device preferably comprises a plurality of distinct sensors. The sensors are optically based. This device will allow for remote, stand-off detection and further, electrical interferences are minimized. A graphical representation of an example of a typical array-based photonic sensor platform is presented in FIG. 1. In one embodiment, the system comprises three (3) components. The excitation component is designed to excite photoluminescence from luminescent probe molecules (also referred to herein as sensing molecules) within the sensors. The sensor is designed such that its optical properties are modified by the presence of the molecules of interest (analytes). While a single sensor is not specific enough to be selective for an analyte, it was unexpectedly observed that a group of sensors was able to generate a pattern of signals that could be specifically correlated with particular non-physiological, physiological or diseased states. It should be noted that the identification of the non-physiological, physiological or diseased state is achieved without the necessity to identify the individual components of the gas or biogas sample. The detector component converts the analyte-altered optical signal (which encodes information about the presence of the analyte and its concentration) to an electrical signal to be processed further. The readout and analysis component may be embodied as software that interprets the signals and relates them to the composition of the actual sample under investigation.

### Excitation Component.

This component contains the light source. Examples of suitable excitation/light sources include commercial, single element light emitting diodes (LEDs) (FIG. 1), LED arrays, lasers, lamps, and radioluminescent (RL) light sources. Interference due to background signals that do not arise from the sensors can be further decreased by the use of an optical filter.

### Sensing Component.

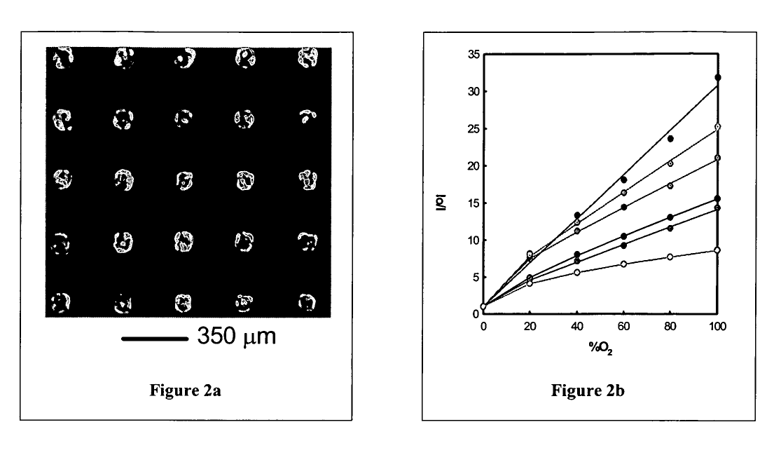

The sensing component is comprised of an array of sensors. The sensors, are comprised of sensing molecules sequestered in a holding material such as sol-gel derived material. In one embodiment the sol-gel derived material is a nanoporous xerogel. In another embodiment the sol-gel derived material is an aerogel. Xerogels offer robust, readily tunable sensor platform with high stability. For example, xerogel-based sensor arrays for the simultaneous determination of O₂, glucose and pH in real time have been developed. FIG. 2a presents a false color fluorescence image from a portion of a xerogel-based sensor element array that was developed for O₂ detection. By controlling the composition of the xerogel, one can readily create sensors with diverse response curves (FIG. 2b). By creating sol-gel-derived xerogel based sensors that exhibit diverse response profiles one can form suites of sensor elements that can exhibit a continuum of response profiles. In turn, an artificial neural network (ANN) to can be trained to “learn” to identify the optical outputs from these xerogel-based sensor arrays. By using the ANN in concert with our tailored sensor arrays, we realized a 5-10 fold improvement in accuracy and precision for quantifying O₂ in unknown samples.

The following are some suitable examples of luminophores that can be used as sensing molecules which can be doped into sol-gel formulations: Rhodamine 6G, Rhodamine B, NBD [nitrobenzo-2-oxa-1,3-diazole], tris(4,7′-diphenyl-1,10′-phenathroline)ruthenium(II), tris(1,10′-phenathroline) ruthenium(II), platinum octaethylporphyrin, pyrene, PRODAN [6-propionyl-2-(N,N-dimethylamino)naphthalene], and DCM [4-(dicyanomethylene)-2-methyl-6-[p-(dimethyl-amino)styryl]-4H-pyran], and Coumarin 153.

While sensors are available for some analytes (such as oxygen), in most situations, there are no known sensors available. To overcome this problem, we created xerogel-based sensor arrays wherein the luminophore (sensing molecules) and the xerogel composition for each distinct sensor are different. In this way one is not designing a specific sensor for an analyte; rather, one is designing a group of sensors that generate unique response patterns for a volatile analyte or an ensemble of volatile analytes. Examples of volatile analytes that can be present in gaseous samples, such as biogas samples, include CO₂, acetone, hydrogen peroxide, ethane, ethanol, pentane, pentanol, isoprene, 2-methylbuta-1,3-diene, hexanal, propanal, pentanal, butanal, 2-methylpropene, 2-octenal, 2-nonenal, 2-heptenal, 2-hexenal, 2,4-decadienal, 2,4-nonadienal, methyl 2,3-dihydroindene, dimethylnaphthalene, alkylbenzene, n-propylheptane, n-octadecane, n-nonadecane, hexadiene, cresol, sabinene, methyl heptanol, methyl ethyl pentanol, trimethylpentanol, decanol, dodecanol, alkyl dioxolane, propenal, C₄-C₂₀ alkanes, 2-butanone, phenol, benzaldehyde, acetophenone, nonanal, ethylpropanoate, methylisobutenoate, NO, 2-methylbutane, trichlorofluoromethane, 2-pentanol, dichloromethane, trichlorethene, benzene, 1-chloro-2-methylbutane, 2,3,3-trimethylpentane, 2,2-dimethylbutane, tetrachloroethene, and CS₂).

In operation, by controlling the xerogel formulation and the doped luminophore one can control the partitioning of the analyte into the xerogel as well as the luminophore's ability to interact with the analyte(s). The interaction between the luminophore within the sensor and the analyte(s) that partition into the xerogel results in a modification of optical properties, for example fluorescence. The fluorescence (i.e., the signal) can be characterized in variety of ways. A broad range of partitioning for enough analytes creates a situation where the response from such a diverse sensor array provides a means to discriminate between samples without actually knowing the exact chemical composition of the samples.

In the operation of the present method, the photoluminescence from a luminophore sequestered within each xerogel sensor is modulated by the presence of a given volatile analyte or volatile analyte mixture. The degree of this modulation (e.g., shift in the luminescence spectrum, change in intensity, change polarization, change in excited-state lifetime) depends on, for example, the luminophore's photophysics, the volatile analyte's identity (e.g., quenching potential, dielectric constant, refractive index), the volatile analyte's concentration in the sample, concentration of other volatile analytes in the sample, the target volatile analyte's solubility coefficient in the xerogel host matrix, the permeability of the host/xerogel to the volatile analyte, and the physiochemical properties surrounding the luminophore within the porous xerogel matrix. Several of these factors are host/xerogel dependent while others depend on the luminescent reporter molecule's photophysics. Thus, by creating large libraries of tailored xerogels that are doped with a range of luminophores, sensor arrays can be developed for screening samples into classes.

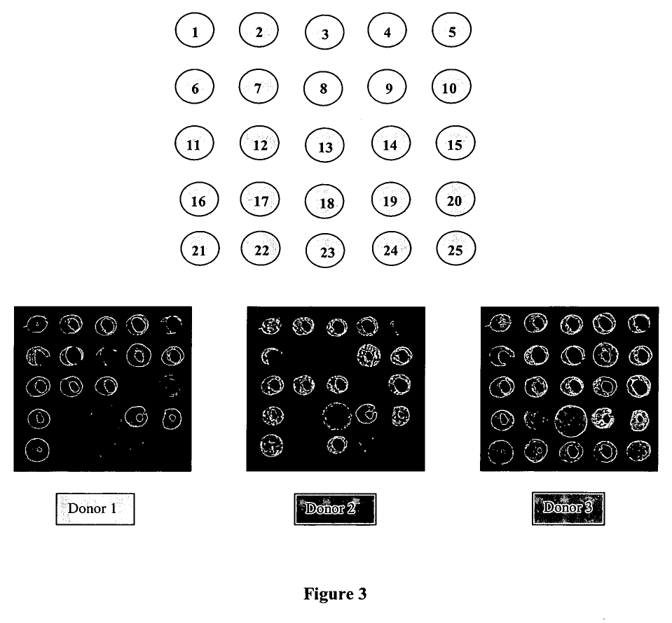

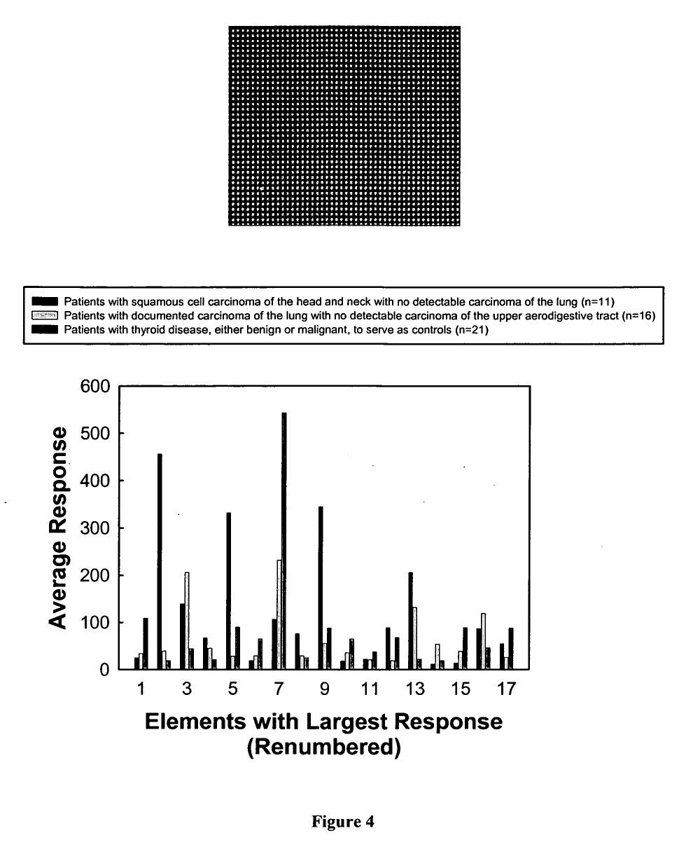

The holding material (also referred to herein as the holding matrix) can be varied by designing various sol-gel-derived formulations. The following are examples of sol-gel precursors: Si(OEt)₄, R—Si(OEt)₄, (EtO)₃—Si—R′—Si(OEt)₃ where R=alkyl, (CH₂)₃—CHO, (CH₂)₃—NH₂, phenyl, phenyl-NH₂, (CH₂)₂-pyridyl, cycloaminopropyl, CH₂—NH-phenyl, (CH₂)₃—N(C₂H₄—OH)₂(CH₂)₃—N⁺—(R″)₃, dihydroimidazole, ureidopropyl, and ethylene diamine tetraacetic acid (EDTA); R′=(CH₂)₃—NH—(CH₂)₃, (CH₂)₃—NH—C₂H₄—NH(CH₂)₃, phenyl, and biphenyl. These precursors were used to form the arrays shown in FIGS. 3 and 4. These particular precursors provide a wide range of dipolarities, hydrogen bond acidities and basicities, and π* values. Thus, by using the above sol-gel precursors or combinations thereof, a variety of holding matrices can be obtained thereby providing a diversity of the response capabilities of each sensor.

The luminophore-doped sol formulations can be printed to form large (e.g. 100,000 element) xerogel-based sensor arrays. Large sensor libraries (˜5 million different formulations) can be prepared by formulating each combination of precursor with each luminophore in, for example, 10 mol % increments. In one embodiment the sensor array comprises at least 10 distinct sensors. In another embodiment the number of sensors in the sensor array comprises any integer from 10 to 100 or 100 to 100,000. For example, arrays can have 100, 1,000, or 10,000 sensors.

### Detection Component.

The detection component is a charged coupled device (CCD) or complementary metal oxide semiconductor (CMOS) camera. An image of the sensor array can be captured by the camera and stored in digital form in, for example, a computer storage subsystem. Preferably, the CCD/CMOS camera is of sufficient resolution and pixel count so the sensors within the sensor array can be analyzed individually for characteristics which can include, for example, color and brightness. The array of sensors can optionally include known, fixed value as registration marks. These registration marks can serve to align the image for processing in the readout and analysis component or to mark the position of specific classes of sensors (e.g., xerogel formulations). Providing the registration mark alignment feature allows for the sensor-to-camera alignment to be less critical than it otherwise would.

### Readout and Analysis Component.

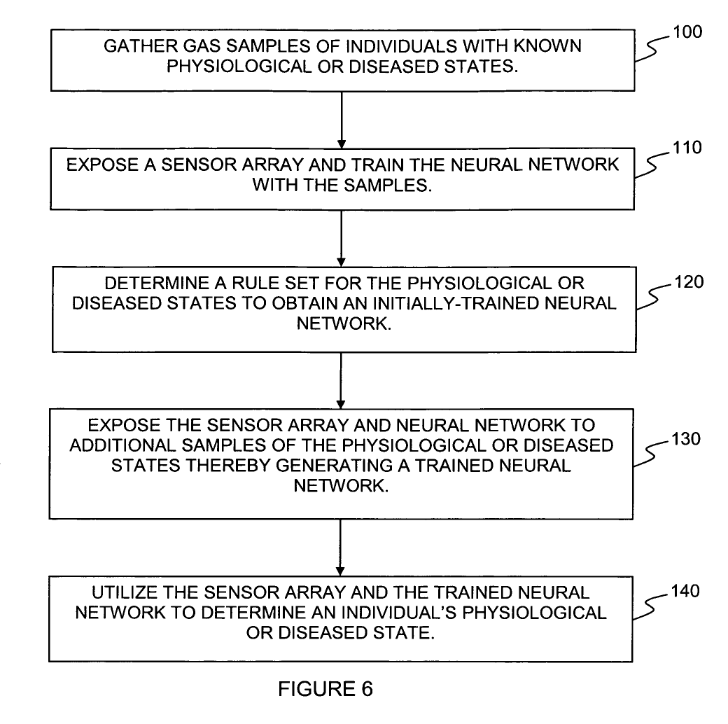

Neural network technology allows for approximating an arbitrary function through learning from observed data. In an embodiment of the present invention, the neural network can be implemented as, for example, a software program which is run on a computer. The software can read the image data from the detection component for processing. The neural network can be trained by exposure to sample data of a known condition. For example, with reference to FIG. 6, gas specimens or biogas specimens of individuals with physiological or diseased states for which the neural network can be trained (for example, diabetics and non-diabetics), are gathered [step 100]. A sensor array and corresponding neural network can be exposed to the gas samples, to train the neural network [step 110]. The recorded sensor array images serve to initially-train the neural network to recognize the sensor pattern associated with the physiological state by determining a rule set for the various trained conditions [step 120]. The ability of the neural network to reliably detect a condition will increase as the number of training samples increases. The neural network can then be challenged to determine the validity of the predetermined rule set and predict the accuracy of the network in detecting the physiological conditions associated with unknown samples, thereby generating a trained neural network [step 130]. The trained neural network can then be used to determine the physiological or diseased states of individuals with unknown conditions [step 140]. Alternatively, if the predetermined rule set is known, an expert system may be trained programmatically.

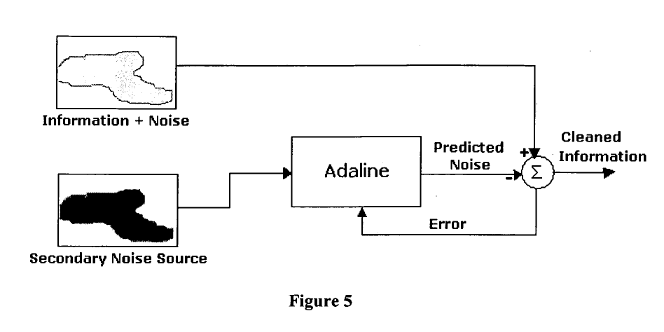

There are several ways to model the data for classification (e.g., Naive Bayes, Bayesian Networks, Neural Networks). Validation procedures such as the K-fold cross validation technique for model selection can be used in anticipation of the size of the training sets (number of subjects that will be used to train and test the sensor system). Clustering of highly responsive sensor elements are then correlated with particular medical conditions. Self-Organizing Maps (SOM) are used in the cluster analysis and visualization. An Adaline-Adaptive Filtering technique can be used (FIG. 5) to eliminate the environmental noise associated with our measurements (e.g., odors not arising from the subject's breath per se). An Adaline-Adaptive Linear Neuron differs from a single perceptron neural net as it continues to learn even from the samples correctly classified. Adaline filtering is, for example, superior compared to a Multi-Layer Perceptron (MLP) trained using a back propagation algorithm for noise cancellation in speech signals. Such filters have been used previously for canceling the maternal heartbeat in fetal electrocardiography and for filtering airplane engine noise from pilot voice signals.

In analyzing the data in FIG. 3 two sequential neural networks were used: a MLP network trained with backward error propagation (BEP) for feature extraction, and the Kohonen self-organizing map (KSOM) for pattern classification. This is called a MLP+KSOM network.

Another method according to the invention utilizes pattern matching techniques in the readout and analysis component. In this method, a pattern may be generated based on the response of the sensor array. The pattern can be, for example, a two-dimensional array of values corresponding to the sensor array, a three-dimensional array of values corresponding to the sensor array, a histogram, or the like. The pattern can be compared to the pattern of a control gas specimen, or a combination of several control gas specimens, to determine the presence or absence of a physiological or diseased state.

The present method can be used to detect physiological or diseased states by comparing a specific pattern obtained from a test biogas specimen to predetermined controls. Examples of diseased states include, but are not limited to, diabetes, cancer (such as early stage lung cancer or breast cancer), HIV/AIDS, and mental illness (such as schizophrenia).

The present method can also be used for detection of non-physiological states by evaluation of gas samples other than biogas samples. For examples, gas samples such as environmental samples, samples from chemical plants or processes or the like can be used. Thus, in this embodiment, the present invention provides a method for matching a test gaseous sample to a predetermined control gas sample. The method comprises: providing a sensor array comprising a plurality of distinct sensors as described above. The array is exposed to the test gas sample and the responses of a plurality of distinct sensors are recorded. The test gas sample and the predetermined control gas sample responses are then compared to evaluate if the two are matching. The evaluation can be done, for example, by visual inspection of the patterns generated by the sensors or by using a trained neural network generated using steps similar to those described in FIG. 6.

The invention is further described through examples 1 and 2 that are included to illustrate the invention and are not intended to be restrictive:

### EXAMPLE 1

This example demonstrates the association of a sensor array response pattern—generated by volatile analytes in the headspace above a urine sample obtained from a patient with diabetes, an altered physiological state. Urine samples were collected from three individuals. The gaseous samples are comprised of head space gases above urine collected from three fasting (14 hours) male donors (first morning voids). Samples 1 and 2 are from normal, healthy donors. Sample 3 is from an otherwise healthy donor with Type 2 diabetes.

FIG. 3 shows raw, unprocessed false color CCD images from a 5×5 xerogel-based sensor array wherein each sensor within the array is derived from a unique xerogel formulation (25 discrete formulations) and each xerogel is doped with the same luminescent reporter molecule (sensing molecule), DCM. The DCM emission spectrum shifts as one changes the physicochemical properties of the local microenvironment surrounding the DCM molecule. Thus, changes in the physicochemical properties within the xerogel induced by the presence of analyte(s) cause the DCM emission to shift and the detected fluorescence to change.

The sol-gel precursors used were: (A) Si(OEt)₄; (B) (EtO)₃Si—(CH₂)₃—NH₂; (C) (EtO)₃—Si—(CH₂)₃—NH—(CH₂)₃—Si(OEt)₃; and (D) (EtO)₃—Si—(CH₂)₇—CH₃. Sensor number and corresponding composition of the so formed xerogels in the array are given in Table 1.

TABLE 1

| Sensor | Sol-gel composition |
|---|---|
| Number | (mol % A/B/C/D) |
| 1 | 33/33/33/33 |
| 2 | 10/10/10/70 |
| 3 | 0/50/50//0 |
| 4 | 10/60/30/0 |
| 5 | 5/90/0/5 |
| 6 | 2/10/80/8 |
| 7 | 95/0/0/5 |
| 8 | 22/45/18/15 |
| 9 | 90/0/0/10 |
| 10 | 60/20/10/10 |
| 11 | 90/0/3/7 |
| 12 | 100/0/0/0 |
| 13 | 20/40/8/32 |
| 14 | 45/45/10/0 |
| 15 | 22/16/0/62 |
| 16 | 33/33/34/0 |
| 17 | 54/25/5/16 |
| 18 | 0/10/10/80 |
| 19 | 20/45/7/28 |
| 20 | 0/0/0/100 |
| 21 | 35/5/50/10 |
| 22 | 9/18/27/46 |
| 23 | 30/30//10/30 |
| 24 | 45/45/0/10 |
| 25 | 16/18/30/36 |

The differences in the response profiles (depicted as false color images), determined by visual inspection, are evident. These readily recognized differences demonstrate that multi-element diversified xerogel array can be used for the detection of volatile analytes for disease diagnostics.

### EXAMPLE 2

This example further demonstrates that sensor array response patterns—generated by volatile analytes in the gaseous expiration, i.e. a patient's breath—are indicative of physiological or diseased states such as cancer. Forty-eight (48) patients breathed into a device comprising a 2500 element sensor array (FIG. 4 top). The patients were categorized as follows:
1. Patients with squamous cell carcinoma of the head and neck with no detectible carcinoma of the lung (eleven (11) patients);
2. Patients with documented carcinoma of the lung with no detectible carcinoma of the upper aerodigestive tract (sixteen (16) patients); and
3. Patients with thyroid disease, either benign or malignant, to serve as controls (twenty one (21) patients.

Twenty five hundred (2500) xerogel-based sensors were formed using one or more of the following sol-gel precursors: Si(OEt)₄, R—Si(OEt)₄, (EtO)₃—Si—R′—Si(OEt)₃ where R=alkyl, (CH₂)₃—CHO, (CH₂)₃—NH₂, phenyl, phenyl-NH₂, (CH₂)₂-pyridyl, cycloaminopropyl, CH₂—NH-phenyl, (CH₂)₃—N(C₂H₄—OH)₂(CH₂)₃—N⁺—(R″)₃, dihydroimidazole, ureidopropyl, and ethylene diamine tetraacetic acid (EDTA); R′=(CH₂)₃—NH—(CH₂)₃, (CH₂)₃—NH—C₂H₄—NH(CH₂)₃, phenyl, and biphenyl. Each xerogel-based sensor was also doped with one of three luminophores.

The sensor responses were categorized and the out puts from the top 17 most diverse responses averaged and compiled (FIG. 4 bottom). The sol-gel precursors used were: (A) Si(OEt)₄; (B) (EtO)₃Si-phenyl-NH₂; and (C) (EtO)₃—Si—(CH₂)₃—NH—(CH₂)₃—Si(OEt)₃. Sensor number and corresponding composition of the so formed xerogels in the array are given in Table 2.

TABLE 2

| Sensor | Sol-gel composition |
|---|---|
| Number | (mol % A/B/C) |
| 1 | 90/4/1 |
| 2 | 10/10/80 |
| 3 | 0/100/0 |
| 4 | 10/40/50 |
| 5 | 18/45/37 |
| 6 | 20/40/20 |
| 7 | 95/0/5 |
| 8 | 11/89/0 |
| 9 | 0/0/100 |
| 10 | 50/50/0 |
| 11 | 100/0/0 |
| 12 | 33/33/34 |
| 13 | 50/25/25 |
| 14 | 10/10/80 |
| 15 | 44/21/35 |
| 16 | 5/5/90 |
| 17 | 30/5/65 |

The sensing molecules used in the sensors are: for 1-6: tris(4,7′-diphenyl-1,10′-phenathroline)ruthenium(II); for 7-11: Rhodamine B; and for 12-17: DCM.

A histogram of the average response of the sensor elements is shown in bottom portion of FIG. 4.

Visual inspection of these data reveal clear differences in the average response patterns from these 17 sensor elements to the breath of patients with (a) squamous cell carcinoma of the head and neck with no detectible carcinoma of the lung; (b) documented carcinoma of the lung with no detectible carcinoma of the upper aerodigestive tract; and (c) thyroid disease, either benign or malignant, to serve as controls.

While the invention has been described through illustrative examples, routine modifications will be apparent to those skilled in the art, which modifications are intended to be within the scope of the invention.

1) A method for diagnosis of a physiological or diseased state comprising the steps of:
a) providing a sensor array comprising a plurality of distinct sensors, wherein each sensors comprises a holding material and a sensing molecule, wherein the holding material is a sol-gel derived material, wherein each distinct sensor differs from other distinct sensors in the holding material, the sensing molecule or both;
b) exposing the sensor array to a test biogas sample;
c) recording the response of a plurality of distinct sensors in the sensor array;
d) generating a pattern based on the response of the plurality of distinct sensors; and
e) comparing the pattern obtained from the test biogas sample to a pattern obtained from a control biogas sample to determine the presence or absence of a physiological or diseased state.

2) The method of claim 1, wherein step e) is carried out by visual inspection.

3) The method of claim 1, wherein the diseased state is selected from the group consisting of diabetes and cancer.

4) The method of claim 1, wherein the sensing molecules are selected from the group consisting of Rhodamine 6G, Rhodamine B, NBD [nitrobenzo-2-oxa-1,3-diazole], tris(4,7′-diphenyl-1,10′-phenathroline) ruthenium(II), tris(1,10′-phenathroline)ruthenium(II), platinum octaethylporphyrin, pyrene, PRODAN [6-propionyl-2-(N,N-dimethylamino)naphthalene], and DCM [4-(dicyanomethylene)-2-methyl-6-[p-(dimethyl-amino)styryl]-4H-pyran], and Coumarin 153.

5) The method of claim 1, wherein the sol-gel derived material is xerogel or aerogel.

6) The method of claim 5, wherein the xerogel is fabricated from precursors selected from the group consisting of Si(OEt)₄, R—Si(OEt)₄, (EtO)₃—Si—R′—Si(OEt)₃ where R=alkyl, (CH₂)₃—CHO, (CH₂)₃—NH₂, phenyl, phenyl-NH₂, (CH₂)₂-pyridyl, cycloaminopropyl, CH₂—NH-phenyl, (CH₂)₃—N(C₂H₄—OH)₂(CH₂)₃—N⁺—(R″)₃, dihydroimidazole, ureidopropyl, and ethylene diamine tetraacetic acid (EDTA); R′=(CH₂)₃—NH—(CH₂)₃, (CH₂)₃—NH—C₂H₄—NH(CH₂)₃, phenyl, and biphenyl and combinations thereof.

7) The method of claim 6) wherein the precursors are selected from the group consisting of Si(OEt)₄; (EtO)₃Si-phenyl-NH₂; and (EtO)₃—Si—(CH₂)₃—NH—(CH₂)₃—Si(OEt)₃, and the sensing molecules are selected from the group consisting of tris(4,7′-diphenyl-1,10′-phenathroline)ruthenium(II), Rhodamine B and [4-(dicyanomethylene)-2-methyl-6-[p-(dimethyl-amino)styryl]-4H-pyran].

8) The method of claim 1, wherein the number of distinct sensor elements in the sensor array is selected from the group consisting of 10 to 100, 101 to 1,000, 1,001 to 10,000 and 10,000 to 100,000.

9) A method for diagnosis of a physiological or diseased state comprising the steps of:
a) providing a sensor array comprising a plurality of distinct sensors, wherein each sensors comprises a holding material and a sensing molecule, wherein the holding material is a sol-gel derived material, wherein each distinct sensor differs from other distinct sensors in the holding material, the sensing molecule or both;
b) exposing the sensor array to a test biogas sample;
c) recording the response of a plurality of distinct sensors in the sensor array; and
d) subjecting the response of the plurality of distinct sensors to a predetermined rule set, wherein the predetermined rule set defines a particular physiological or diseased state, thereby identifying the presence or absence of a particular physiological or diseased state.

10) The method of claim 9, wherein the known set of responses is obtained by training a neural network using responses of sensors exposed to biogas sample from individuals with known physiological states.

11) The method of claim 9, wherein the sensing molecules are selected from the group consisting of Rhodamine 6G, Rhodamine B, NBD [nitrobenzo-2-oxa-1,3-diazole], tris(4,7′-diphenyl-1,10′-phenathroline) ruthenium(II), tris(1,10′-phenathroline)ruthenium(II), platinum octaethylporphyrin, pyrene, PRODAN [6-propionyl-2-(N,N-dimethylamino)naphthalene], and DCM [4-(dicyanomethylene)-2-methyl-6-[p-(dimethyl-amino)styryl]-4H-pyran] and Coumarin 153.

12) The method of claim 9, wherein the sol-gel derived material is a xerogel or an aerogel.

13) The method of claim 12, wherein the xerogel is fabricated using precursors selected from the group consisting of Si(OEt)₄, R—Si(OEt)₄, (EtO)₃—Si—R′—Si(OEt)₃ where R=alkyl, (CH₂)₃—CHO, (CH₂)₃—NH₂, phenyl, phenyl-NH₂, (CH₂)₂-pyridyl, cycloaminopropyl, CH₂—NH-phenyl, (CH₂)₃—N(C₂H₄—OH)₂(CH₂)₃—N⁺—(R″)₃, dihydroimidazole, ureidopropyl, and ethylene diamine tetraacetic acid (EDTA); R′=(CH₂)₃—NH—(CH₂)₃, (CH₂)₃—NH—C₂H₄—NH(CH₂)₃, phenyl, and biphenyl, and combinations thereof.

14) The method of claim 9, wherein the number of distinct sensor elements in the sensor array is selected from the group consisting of 10 to 100, 101 to 1,000, 1,001 to 10,000, and 10,000 to 100,000.

15) The method of claim 9, wherein the diseased state is selected from the group consisting of diabetes and cancer.

16) A method for matching a test gaseous sample to a predetermined control gas sample comprising the steps of:
a) providing a sensor array comprising a plurality of distinct sensors, wherein each sensors comprises a holding material and a sensing molecule, wherein the holding material is a sol-gel derived material, wherein each distinct sensor differs from other distinct sensors in the holding material, the sensing molecule or both;
b) exposing the sensor array to a test gas sample;
c) recording the response of a plurality of distinct sensors in the sensor array; and
d) comparing the response from a plurality of distinct sensors from the test gas sample to the response from the predetermined control gas sample to determine whether or not the test gas sample matches the predetermined control sample.

17) The method of claim 16, wherein the comparing in step d) is carried out by visual inspection.

18) The method of claim 16, wherein the comparing in step d) is carried out by subjecting the response of the plurality of distinct sensors to a predetermined rule set, wherein the predetermined rule set defines the predetermined control gas, thereby enabling matching of the test gas sample with the predetermined control gas sample.

19) The method of claim 16, wherein the sol-gel derived material is a xerogel or an aerogel.

20) The method of claim 19, wherein the sensing molecules are selected from the group consisting of Rhodamine 6G, Rhodamine B, NBD [nitrobenzo-2-oxa-1,3-diazole], tris(4,7′-diphenyl-1,10′-phenathroline)ruthenium(II), tris(1,10′-phenathroline)ruthenium(II), platinum octaethylporphyrin, pyrene, PRODAN [6-propionyl-2-(N,N-dimethylamino)naphthalene], and DCM [4-(dicyanomethylene)-2-methyl-6-[p-(dimethyl-amino)styryl]-4H-pyran], and Coumarin 153, and the xerogel is fabricated using precursors selected from the group consisting of Si(OEt)₄, R—Si(OEt)₄, (EtO)₃—Si—R′—Si(OEt)₃ where R=alkyl, (CH₂)₃—CHO, (CH₂)₃—NH₂, phenyl, phenyl-NH₂, (CH₂)₂-pyridyl, cycloaminopropyl, CH₂—NH-phenyl, (CH₂)₃—N(C₂H₄—OH)₂ (CH₂)₃—N⁺—(R″)₃, dihydroimidazole, ureidopropyl, and ethylene diamine tetraacetic acid (EDTA); R′=(CH₂)₃—NH—(CH₂)₃, (CH₂)₃—NH—C₂H₄—NH(CH₂)₃, phenyl, biphenyl and combinations thereof.
